(19) United States
(12) Patent Application Publication
(10) Pub. No.: US 2019/0320690 A1
(43) Pub. Date: Oct. 24, 2019

(54) PROCESS-STABLE OPACIFYING COMPOSITIONS WITH MICRONIZED HIGH-FIBER FOOD STARCH FOR FOOD PRODUCTS AND METHODS

(71) Applicant: Campbell Soup Company, Camden, NJ (US)

(72) Inventor: Keswara Rao Vadlamani, Marlton, NJ (US)

(21) Appl. No.: 16/392,239

(22) Filed: Apr. 23, 2019

Related U.S. Application Data
(60) Provisional application No. 62/661,714, filed on Apr. 24, 2018.

(51) Int. Cl. A23L 5/43; A23L 23/00

(52) U.S. Cl. CPC A23L 5/43; A23V 2002/00; A23L 23/00

(57) ABSTRACT

Embodiments herein include opacifying compositions, food products made with the same, and related methods. In an embodiment, a processed food product is included. The processed food product can include an opacifying agent such as, a modified food starch (RS4) with at least 70 wt. % fiber and having a particle size of dv 98% less than 25 μm. The brightness (L*) value of the processed food product is greater than 70. Other embodiments are also included herein.

This application claims the benefit of U.S. Provisional Application No. 62/661,714, filed Apr. 24, 2018, the content of which is herein incorporated by reference in its entirety.

### FIELD

Embodiments herein relate to opacifying agent for food products and related methods. More specifically, embodiments herein relate to process-stable opacifying agents for food products and related methods.

### BACKGROUND

Titanium dioxide is a common additive and widely used to provide whiteness and opacity to products such as paints, plastics, papers, inks, foods, and toothpastes. It is also used in cosmetic and skin care products, and it is present in almost every sunblock, where it helps protect the skin from ultraviolet light. It also functions as an anti-caking agent, texturizer (chocolate, doughnuts), and as an abrasive agent (toothpaste).

Titanium dioxide accounts for 70% of the total production volume of pigments worldwide. Titanium dioxide is an inert and insoluble material, and not easily absorbed into the body from food. Titanium dioxide is considered Generally Recognized as Safe (GRAS) by the U.S. Food and Drug Administration.

However, consumer demand for natural and clean-label ingredients is a leading and ongoing trend that requires developing new food products with consumer-friendly ingredients, while delivering on taste and appearance. Titanium dioxide has been used as a whitening agent in many food products in the past, but its use is increasingly not perceived positively by consumers.

### SUMMARY

Embodiments herein include opacifying compositions, food products made with the same, and related methods. In an embodiment, a processed food product is included. The processed food product can include a modified food starch (RS4) with at least 70 wt. % fiber. The brightness (L*) value of the processed food product is greater than 70.

In an embodiment, an opacifying composition is included having a modified food starch (RS4) with at least 70 wt. % fiber. The brightness (L*) value of the composition is greater than 80 at a concentration of 1 wt. % in an aqueous solution.

In an embodiment, a method of making a processed food product is included herein. The method can include adding an opacifying composition to a formulation, an opacifying composition including a modified food starch (RS4) with at least 70 wt. % dietary fiber. The method can further include forming an emulsion with the formulation and the opacifying composition. The method can further include blending the emulsion with other components to form a mixture. The method can further include processing the mixture to form a finished product.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection, with the following drawings, in which:

FIG. 1 is a graph showing the effect of the particle size reduction on the whitening capacity of an opacifying agent.

FIG. 2 is a graph showing particle size distribution for a opacifying agent before and after micronization.

FIG. 3 is a graph showing particle size distribution for a opacifying agent before and after micronization.

FIG. 4 is a schematic view of a food product in accordance with various embodiments herein.

FIG. 5 is a schematic view of a food product in accordance with various embodiments herein.

While embodiments are susceptible to various modifications and alternative forms, specifics thereof have been shown by way of example and drawings, and will be described in detail. It should be understood, however, that the scope herein is not limited to the embodiments described. On the contrary, the intention is to cover modifications, equivalents, and alternatives falling within the spirit and scope herein.

### DETAILED DESCRIPTION

In view of recent consumer concern about titanium dioxide, there is a need for alternative whitening agents for foods. Current alternatives to titanium dioxide include ingredients such as calcium carbonate and rice starch. However, calcium carbonate and rice starch do not perform well in some food compositions, especially soups and baked snacks. Moreover, these ingredients have several limitations. For example, calcium carbonate changes the pH of the food systems, provides a dull white appearance, imparts chalky mouthfeel and an undesirable flavor. Rice starch is not suitable for canned soup applications. During retort processing, rice starch gelatinizes and loses its opacity. Rice starch also imparts high viscosity.

Embodiments herein address the unmet need for consumer-friendly titanium dioxide free whitening compositions for application in high-moisture (50% moisture or more) and heat-processed products such as soups, dips, and baked snacks.

Various embodiments herein include titanium-dioxide free food compositions. The term “titanium-dioxide free” as used herein shall refer to food compositions with no added titanium dioxide and therefore including only whatever trace amounts of titanium dioxide may be included within other components of food formulations.

Various embodiments herein include food compositions with very low amounts of titanium dioxide. By way of example, food compositions herein can include less than 0.75, 0.5, 0.4, 0.3, 0.2, 0.1, 0.05, or 0.01 wt. % titanium dioxide.

It has been discovered herein that a unique highly cross-linked modified food starch (RS4 resistant starch) with controlled particle size is highly effective in whitening food products, is process tolerant, neutral to pH and does not significantly affect taste.

### Starch

Starch consists of two kinds of glucose polymers (amylose and amylopectin). Depending on the plant, starch generally contains 20-25% amylose and 75-80% amylopectin. In general, grain-derived starches have a higher amylose content than tuber-derived starches. Table 1 below shows the characteristics of some starch granules.

TABLE 1
Characteristics of some starch granules

| | | Size of Grain (in μm) | | |
|---|---|---|---|---|
| Starch | Type | Range | Average | Shape |
| potato | tuber | 5-100 | 40 | oval spherical |
| maize | grain | 2-30 | 15 | round polygonal |
| wheat | grain | 1-45 | 25 | round lenticular |
| tapioca | root | 4-35 | 25 | oval truncate |
| waxy maize | grain | 3-26 | 15 | round polygonal |

Starches used herein can have an average grain size of about 5, 10, 15, 20, 25, 30, 35, 40, 45, 50, 55, or 60 μm. In some embodiments, the starches used herein can have a grain size in a range wherein any of the foregoing grain sizes can serve as the upper or lower bound of the range, provided that the upper bound is greater than the lower bound.

Cross-linking is a modification method used to improve the performance of native starches. Cross-linking reinforces the granules of starch to be more resistant to degradation from pH, heat, and shear. One such cross-linking technique performed on starch is by chemical modification with sodium trimetaphosphate and sodium tripolyphosphate under controlled conditions to create a highly cross-linked starch. The important property of this starch is that it is resistant to digestion and therefore considered a dietary fiber. In various embodiments, the starch is a type RS4 resistant starch.

The modified food starch (RS4) can contain at least about 60%, 65%, 70%, 75%, 80%, 85%, 90%, or 95% total dietary fiber as measured by AOAC method 991.43. In some embodiments, the modified food starch can contain an amount of dietary fiber in a range wherein any of the foregoing amounts can serve as the upper or lower bound of the range, provided that the upper bound is greater than the lower bound. In some embodiments, the modified food starch can contain at least about 70% total dietary fiber as measured by AOAC method 991.43.

Examples of these starches are sold under the trade names of FIBERSYM RW (Midwest Grain Products, Inc.); ACTISTAR RT (Cargill), and VERSAFIBE (Ingredion). Particle sizes (size distribution) of these starches vary significantly. Fibersym RW modified food starch has a particle size ranging from dv100%=88 μm; dv 90%=37 μm; and dv50%=22 μm. Actistar RT modified food starch has a particle size ranging from dv100%=63 μm; dv90%=26 μm; and dv50%=15 μm. dv100% regarding a particular size refers to a particle size distribution wherein 100% of the particles (number count) are less than or equal to the specified size.

In various embodiments, the modified food starch is low in calories, has low water binding capacity (0.7 g water/g) neutral in flavor, exhibits a smooth non-gritty texture and is process tolerant.

In some embodiments, the modified food starch has less than 2.0, 1.5, 1.0, 0.75, 0.5, 0.25 or 0.10 kcal/g. In some embodiments, the modified food starch has kilocalories per gram that is in a range wherein any of the foregoing amounts can serve as the upper or lower bound of the range, provided that the upper bound is greater than the lower bound. In some embodiments, the modified food starch has less than 0.5 kcal/g.

In some embodiments, the modified food starch has a water binding capacity of less than 1.9 g water/g, 1.7 g water/g, 1.5 g water/g, 1.3 g water/g, 1.1 g water/g, 0.9 g water/g, 0.7 g water/g, 0.5 g water/g, 0.3 g water/g, or 0.1 g water/g. In some embodiments, the modified food starch has an amount of water binding capacity that is in a range wherein any of the foregoing amounts can serve as the upper or lower bound of the range, provided that the upper bound is greater than the lower bound. In some embodiments, the modified food starch has a water binding capacity of less than 0.7 g water/g.

The total amount of the modified food starch added to a food product can vary based on many factors including the desired degree of opacity, the starting color of the food product, and the like. In various embodiments, the amount of modified food starch, as a percent of the total weight of the food product including all other ingredients, can be about 0.1, 0.25, 0.5, 0.75, 1, 2, 3, 4, 5, 7.5, 10, 12.5, 15, 17.5 or 20 wt. %. In some embodiments, the amount of modified food starch can be in a range wherein any of the foregoing amounts can serve as the upper or lower bound of the range, provide that the upper bound is greater than the lower bound.

### Micronization—Particle Size Reduction:

The opacifying ingredient—modified food starch (RS4) can be subjected to particle size reduction techniques such as jet milling, wet milling or other suitable methods.

In some embodiments, the particle size distribution of modified food starch is reduced to dv 100% or dv 98% equaling 25 μm, 20 μm, 15 μm, 10 μm, 6.5 μm, 5 μm, of 1 μm (wherein dv 100% regarding a particular size refers to a particle size distribution wherein 100% of the particles on a number count basis are less than or equal to the specified size). In some embodiments, the particle size distribution of modified food starch is reduced such that the dv 50% value is equal to 15 μm, 10 μm, 6.5 μm, 5 μm, 1 μm, or 0.5 μm (wherein dv 50% regarding a particular size refers to a particle size distribution wherein 50% of the particles on a number count basis are less than or equal to the specified size). In some embodiments, the particle size of modified food starch is dv 100%=22 μm. In some embodiments the particle size of modified food starch is dv 97%=15 μm. In some embodiments, the particle size of modified food starch is dv 85%=10 μm. In some embodiments, the particle size of modified food starch is dv 50%=7 μm.

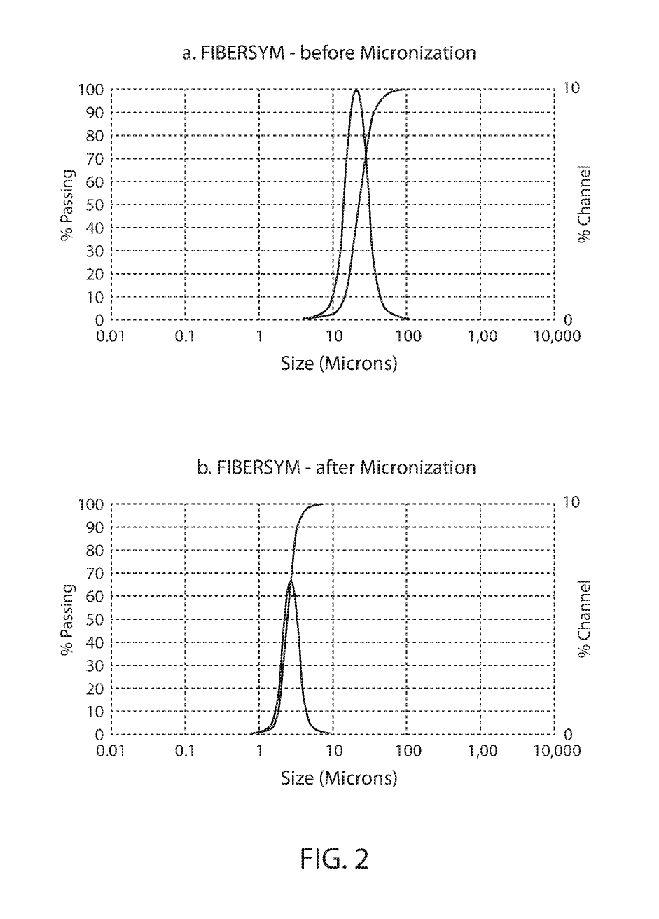

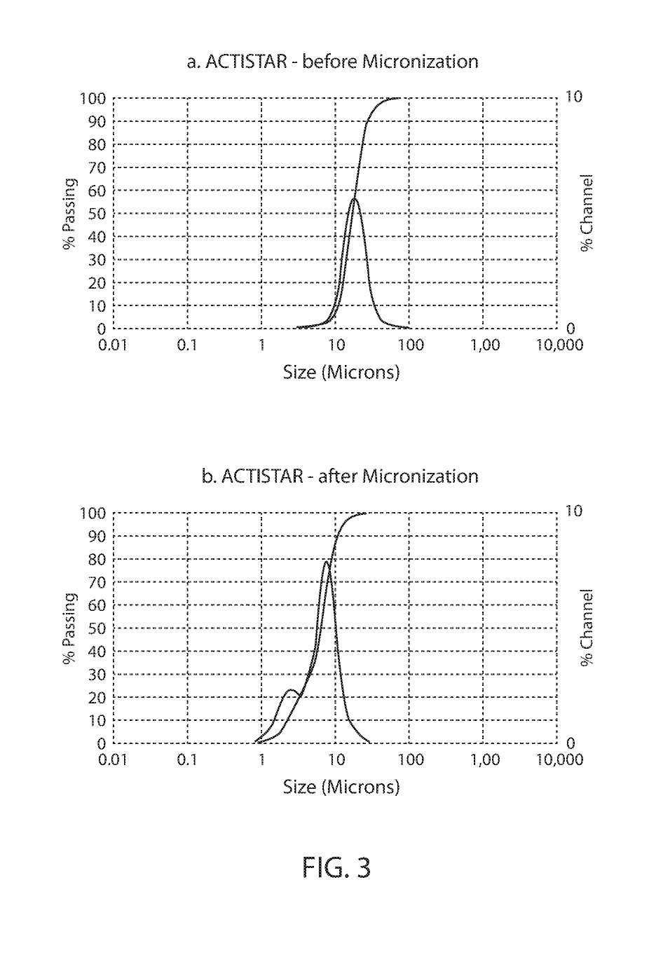

The effect of micronization on changes in particle size distribution before and after are illustrated in FIGS. 2a and 2b for Fibersym RW and in FIGS. 3a and 3b for Actistar RT. Micronization in those examples was performed using a jet milling system.

### Processed Food Products and Other Ingredients

Processed foods herein can include and but not limited to: reduced-fat/low-fat, refrigerated and shelf-stable soups, cheese dips, white sauces, salad dressings, bakery products, baked snacks, and confectionary fillings and coatings.

While not intending to be bound by theory, it is believed that it is technically challenging to produce low-fat processed food while still achieving a brightness and/or whiteness approaching that of an otherwise comparable full-fat content analog. Some processed food products herein can be low-fat. In various embodiments, processed food products can contain less than 10, 7.5, 5, 2.5 or 1 gram of fat per serving. For example, processed food products herein can contain less than 5 grams of fat per 8 ounce serving.

Some processed food products herein can be low in calories. In various embodiments, processed food products herein can contain less than 200, 175, 150, 125, 100, 75 or 50 calories (kcals) per serving. For example, processed food products herein can contain less than 100 calories per serving.

The total amount of the opacifying composition in the processed food product can vary. In some embodiments the processed food product can include about 0.1, 0.5, 1, 1.5, 2, 3, 4, 5, 6, 8, or 10 wt. % of the opacifying composition. In some embodiments, the amount of the opacifying composition in the processed food product can be in a range wherein any of the foregoing numbers can serve as the upper or lower bound of the range, provided that the upper bound is greater than the lower bound. In some embodiments, the processed food product can contain from 1 wt. % to 5 wt. % of the modified food starch (RS4). In some embodiments, the processed food product can contain from 1 wt. % to 3 wt. % of the modified food starch (RS4).

Some processed food products such as soups herein can contain other ingredients including, but not limited to, fresh cream, butter, liquid oils such as canola, soy bean, etc., thickening agents such as starches, hydrocolloids and wheat flour, soy protein, whey protein, meat broths, meats, pasta, cheeses, vegetables, salt, sugar, yeast extracts, monosodium glutamate, and flavorings.

Some processed food products such as dips here in can contain other ingredients including, but not limited to, cheeses (cheddar, monterey jack); thickeners (modified starches, maltodextrins), hydrocolloids (xanthan gum, guar gum, carrageenan, cellulose, etc.), liquid oils (soy, canola, etc.); buffering agents (citrate and phosphate salts), acidulants (lactic acid, vinegar); emulsifiers (DATEM, mono and di glycerides), dehydrated vegetables, salt, and flavorings.

Some processed food products such as white sauces here in can contain other ingredients including, but not limited to, cheeses (cheddar, monterey jack, etc.); thickeners (modified starches, maltodextrins), hydrocolloids (xanthan gum, guar gum, carrageenan, cellulose, etc.), liquid oils (soy, canola, etc.); buffering agents (citrate and phosphate salts), acidulants (lactic acid, vinegar); emulsifiers (DATEM, mono and di glycerides, lecithin), dehydrated vegetables, salt, and flavorings.

Some processed food products such as bakery products and baked snacks here in can contain other ingredients including, but not limited to, flours (wheat, rice, tapioca, potato, sorghum, etc.); cheeses (cheddar, monterey jack, parmesan, romano, etc.); thickening agents (modified starches, maltodextrins), hydrocolloids (xanthan gum, guar gum, carrageenan, cellulose, etc.), liquid oils (soy, canola, etc.); leavening agents (sodium bicarbonate, ammonium bicarbonate), salt, sugar, yeast, yeast extracts, spices and flavors.

Some processed food products such as confectionary coatings and fillings herein can contain other ingredients including, but not limited to, fats and oils (soy, canola, etc.) sugars, flours (wheat, rice, tapioca, potato); thickening agents (modified starches, maltodextrins), hydrocolloids (xanthan gum, guar gum, carrageenan, cellulose, etc.), emulsifiers (DATEM, mono and diglycerides, lecithin); salt, sugar, flavors and food colors (natural and artificial).

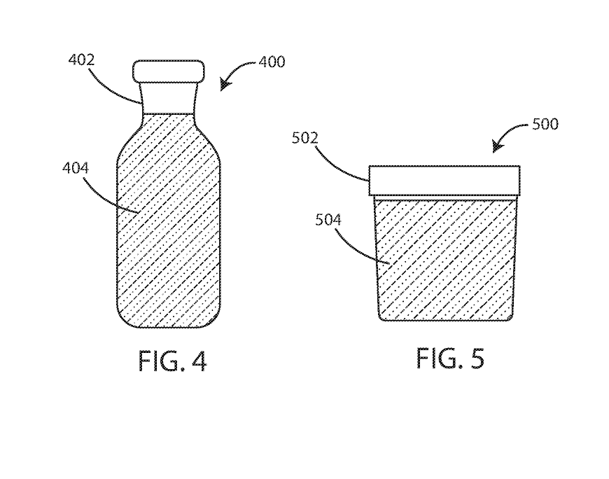

Referring now to FIG. 4, a schematic view is shown of a food product 200 in accordance with various embodiments herein. The food product 200 can include a container 202 and food material 204 disposed within the container 202. The food product 204 can be any of the foods described above.

Referring now to FIG. 5, a schematic view is shown of a food product 300 in accordance with various embodiments herein. The food product 300 can include a container 302 and a food material 304 disposed within the container 302. The food material 304 can be any of the foods described above.

### Color Measurement:

It will be appreciated that color can be assessed in various ways. In some embodiments, a Hunter Colorimeter can be used to measure color values L* (Whiteness), a* (green to red) and b*(blue to yellow). The value for L* vary from 100 (White) to 0 (Black). The a* and b* have no specific numerical scale (e.g., possible values are not confined to a particular range). Positive a* is red. Negative a* is green. Positive b* is yellow. Negative b* is blue. The higher the L* value the brighter and whiter the color.

In some embodiments, the opacifying composition can have a brightness (L*) values of 70, 75, 80, 85, 90, and 95 (such as when measured at a concentration of 1 wt. % in an aqueous solution). In some embodiments, the brightness (L*) value can be in a range wherein any of the foregoing can serve as the upper or lower bound of the range. In an embodiment, the brightness (L*) values can be up to 85, 90, or 95.

In some embodiments, an amount of opacifying composition is added to a food product to result in a change of brightness (L*) of the food product of at least about 2, 5, 10, 15 or 20 as measured with a Hunter Colorimeter.

In some embodiments, a food product with the opacifying composition can have a brightness (L*) values of 60, 65, 70, 75, 80, 85, 90, or 95. In some embodiments, the brightness (L*) value can be in a range wherein any of the foregoing can serve as the upper or lower bound of the range. In an embodiment, the brightness (L*) values can be up to 75, 80, 85, 90, or 95.

In some embodiments, the opacifying composition can have a yellowness (b*) values of −1.0, 0, 1.0, 2.0, 3.0, 4.0, and 5.0. In some embodiments, the yellowness (b*) value can be in a range wherein any of the foregoing can serve as the upper or lower bound of the range. In an embodiment, the yellowness (b*) values can be up to −1.0, 1.0 and 3.0.

In some embodiments, the opacifying compositions can have a redness (a*) values of −2.0, −1.0, −0.5 and 0. In some embodiments, the redness (a*) value can be in a range wherein any of the foregoing can serve as the upper or lower bound of the range. In an embodiment, the redness (a*) values can be up to −1.5, −1.0 and −0.5.

Aspects of beneficial color properties herein and, in particular, brightness (L*) values can exhibit a remarkable degree of heat stability. In various embodiments, the Hunter Colorimeter brightness (L*) value of the food product and/or composition decreases by less than about 25, 20, 15, 12.5, 10, 7.5, 5 or 2.5 (L*) as a result of heat treating (such as described below) the mixture.

### Methods:

In an embodiment, a method of making a processed food product is included. The method can include adding an opacifying composition to a food formulation. The opacifying composition can include modified food starch (RS4) with at least 70 wt. % dietary fiber. The method can further include forming an emulsion with the formulation and the opacifying composition. The method can further include blending the emulsion with other components to form a mixture. The method can further include processing the mixture to form a finished product.

In some embodiments, the method can include placing the mixture within a food container. In some embodiments, the method can include hermetically sealing the mixture within a food container. Food containers can include, but are not limited to, cans, jars, tubs, boxes, pouches, bottles, glasses, and the like. The food containers can be opaque, translucent, transparent, or the like. In some embodiments, the food container is transparent.

In some embodiments, the method can include thermally processing (or heat treating) the mixture. In some embodiments, the method can include thermally processing the mixture at a temperature of 190 degrees Fahrenheit or greater. In some embodiments, the temperature can exceed 200, 210, 220, 230, or 250 degrees Fahrenheit (or within a temperature range between any of the foregoing) for at least about 2, 5, 10, 15, 20, 25, or 30 minutes (or within a time range between any of the foregoing). In some embodiments, thermal processing can be performed at an elevated pressure. In some embodiments, the method can include retort cooking (or retorting) the mixture. In some embodiments, the method can include baking the mixture. In some embodiments, the method can include exposing the mixture to electromagnetic waves.

Aspects may be better understood with reference to the following examples. These examples are intended to be representative of specific embodiments, but are not intended as limiting the overall scope of embodiments herein.

### EXAMPLES

### Example 1: Opacifying Agent—Opacity as a Function of Concentration

In this example, the opacity as a function of concentration was demonstrated by measuring their color values. Modified Food Starch (RS4)-70% Fiber (non-micronized), and Titanium Dioxide solutions at varying concentrations were prepared in distilled water. The solutions were stirred well, filled into sample cup and the color (L*, a*, b*) was measured by Hunter Colorimeter. The pH was also measured for Modified Food Starch (RS4)-70% Fiber solutions. The results are shown in Table 2 and Table 3. As results indicate, a steep increase in opacity was observed up to 3% of concentration for modified food starch and continue to increase with higher concentration. The pH values remained neutral and varied from 6.5-7.3. Similar results were observed for TiO2 dispersion as well.

TABLE 2

| | |
|---|---|
| Opacifying Components | |
| Modified Food Starch(RS4) - | Color |

| Non-Micronized | pH | L* | a* | b* |
|---|---|---|---|---|
| 1% | 7.16 | 58.80 | −0.30 | 0.11 |
| 2% | 7.00 | 73.00 | −0.32 | 0.85 |
| 3% | 6.86 | 80.20 | −0.39 | 1.37 |
| 5% | 6.70 | 85.90 | −0.46 | 2.21 |
| 10% | 6.48 | 91.00 | −0.42 | 4.00 |

TABLE 3

| % TiO2 Dispersion | L* | a* | b* |
|---|---|---|---|
| 0.25% | 89.80 | −1.10 | 1.99 |
| 0.50% | 93.20 | −1.06 | 4.24 |
| 0.75% | 94.10 | −0.91 | 6.49 |
| 1.00% | 94.50 | −0.72 | 6.88 |

### Example 2: Particle Size Reduction (Micronizing) and its Effect on Opacifying Capacity

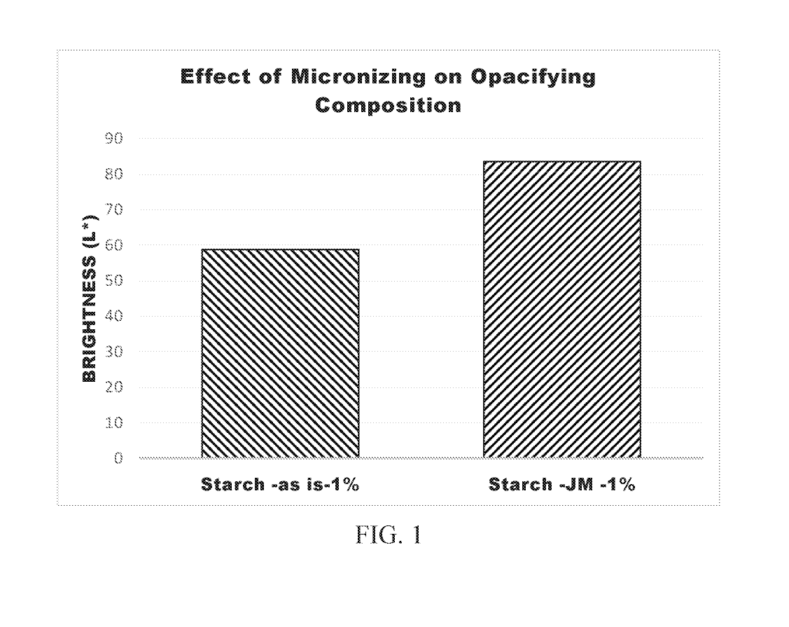

In this example, modified food starch (RS4) sample was jet-milled to varying particle sizes. The opacifying capacity of these micronized samples was compared against the unprocessed raw ingredient. The sample solutions were prepared in distilled water, stirred, filled into sample cup and the color (L*, a*, b*) was measured by Hunter Colorimeter. The results are shown in FIG. 1 and Table 4. Results show a dramatic improvement (+25 pts) in brightness (L*) value for particle size reduced modified food starch.

TABLE 4

| | Color | | |
|---|---|---|---|
| Ingredient | L* | a* | b* |
| Modified Food Starch (RS4) - | 58.80 | −0.30 | 0.11 |
| Non-Micronized dv100% = 88 | | | |
| μm) -1% Solution | | | |
| Modified Food Starch (RS4) - | 83.50 | −1.31 | −1.05 |
| Micronized (dv 100% = 6.5 | | | |
| μm)- 1% Solution | | | |

### Example 3: Retort Process Tolerance of the Opacifying Composition

In this example, the heat stability of titanium dioxide free opacifying compositions was evaluated. 500 ml each of: (1) control—0.2% titanium dioxide, (2) 3.0% Modified Food Starch (RS4—Non-Micronized (dv100%=88 μm), (3) 2.0% Modified Food Starch (RS4) (Micronized) (dv100%=6.5 μm) solutions were prepared. The solutions were stirred well and filled into cans, sealed, and retort processed in a pressure cooker at 250° F. for 20 minutes. The cans were cooled immediately after processing. The color measurements (L*, a*, b*) were taken on both pre- and post-retort processed samples using Hunter Colorimeter. The results shown in Table 5 below show that the modified food starch retained 85-90% of its initial opacity, indicting its relative stability to retort processing.

TABLE 5

| Ingredient | L* | a* | b* |
|---|---|---|---|
| TiO₂ - 0.2% Solution | | | |
| Pre-Retort | 84.4 | −0.6 | −0.3 |
| Post-Retort | 85.9 | −1.2 | 1.0 |
| Modified Food Starch (RS4) | 79.7 | −0.4 | 1.35 |
| (Non-Micronized) - 3% Solution | 69.4 | −0.9 | 1.69 |
| Pre-Retort | | | |
| Post-Retort | | | |
| Modified Food Starch (RS4) | | | |
| (Micronized) - 2% Solution | | | |
| Pre-Retort | 86.31 | −1.07 | −1.97 |
| Post-Retort | 78.79 | −1.14 | 0.13 |

### Example 4: Opacifying Capacity Comparison of Various Food Starches

In this example, various starches were compared for the opacifying capacity both in their native and as well as in cooked forms. All starch solutions were prepared at 3% concentration by weight. The raw starch solutions were stirred, filled into sample cup and color was measured. Also, the starch solutions were heated in microwave for up to 90 sec to fully cook the starches. The samples were cooled and color was measured. The results as shown in Table 6, indicate that modified food starch (RS4)(70% fiber) was shown to be the most stable and effective opacifier, retaining 85-90% of original brightness, compared to other native and modified food starches.

TABLE 6

| | Particle | | | | | | | | | |
|---|---|---|---|---|---|---|---|---|---|---|
| | Size | | | | | | | | | |
| | (um) | | Raw | | | Retorted | | | % Opacity | |
| Starch | D50 | D100 | L* | a* | b* | L* | a* | b* | Retention | Observations |
| Modified Food | 22 | 88 | 79.70 | −0.40 | 1.35 | 69.40 | −0.90 | 1.70 | 87.10% | Stable Color |
| Starch (RS4)-70% | | | | | | | | | | No Viscosity |
| Fiber | | | | | | | | | | |
| Rice Starch-Native | 17.5 | 104 | 89.70 | −0.60 | −0.40 | 43.40 | −1.70 | −10.60 | 48.40% | Increased |
| | | | | | | | | | | Clarity and |
| | | | | | | | | | | Viscosity |
| Waxy Rice Starch- | 17.5 | 104 | 83.40 | −0.40 | 7.49 | 25.10 | −0.90 | −1.26 | 30.10% | Increased |
| Native | | | | | | | | | | Clarity and |
| | | | | | | | | | | Viscosity |
| Modified Food | 15.0 | 43 | 79.00 | −0.60 | −0.50 | 27.30 | −0.60 | −3.60 | 34.50% | Increased |
| Starch-1-Waxy | | | | | | | | | | Clarity and |
| Maize (Non-RS4) | | | | | | | | | | Viscosity |
| Modified Food | 15.5 | 49 | 81.40 | −0.60 | −0.04 | 31.20 | −0.70 | −3.80 | 38.20% | Increased |
| Starch-2 (Non- | | | | | | | | | | Clarity and |
| RS4) | | | | | | | | | | Viscosity |
| Modified Food | 13.5 | 33 | 81.30 | −0.70 | 0.10 | 30.10 | −0.80 | −4.80 | 37.00% | Increased |
| Starch-3(Non- | | | | | | | | | | Clarity and |
| RS4) | | | | | | | | | | Viscosity |

### Example 5: Low Fat Cream Soups with Micronized Opacifying Compositions

In this example, a low fat Creamy Chicken Alfredo soup recipe (1 g Fat, 100 Calories) was used to evaluate the efficacy of titanium dioxide free opacifying compositions. The variables prepared include: a blank (B) without titanium dioxide; a control (C) with titanium dioxide dispersion at 0.6%; and a test variable (T) with 2% Micronized (6.5 μm) Modified Food Starch (RS4). The soup variables were prepared, filled into cans, sealed, and retort processed. The color measurements (L*, a*, b*) on processed soups were made using Hunter Colorimeter. The samples were evaluated by the team. As shown below in Table 7, addition of the micronized modified food starch to the formulation, significantly improved the overall opacity (brightness) of soup and comparable to TiO₂. The test product was found to be acceptable in color, taste, and texture.

TABLE 7

| | Color | | |
|---|---|---|---|
| Creamy Chicken Alfredo Soup | L* | a* | b* |
| Blank - No Whitener | 62.76 | 0.41 | 16.24 |
| Control - with TiO2 | 81.81 | −0.66 | 14.41 |
| Test - 2% Modified Food Starch (RS4) (Micronized) | 81.24 | 1.03 | 16.56 |

### Example 6: Reduced-Fat Light Soups with Micronized Opacifying Compositions

In this example, a New England Clam Chowder (NECC) Light soup recipe (4 g Fat and 100 calories) was used to evaluate the efficacy of titanium dioxide free opacifying compositions. The variables prepared include: a blank (B) without titanium dioxide; a control (C) with titanium dioxide dispersion at 0.3%; and a test variable (T) with 2% Micronized Modified Food Starch (RS4). The soup variables were prepared, filled into cans, sealed, and retort processed. The test product made with modified food starch was found to be acceptable in color, taste, and texture.

TABLE 8

| | Color | | |
|---|---|---|---|
| New England Clam Chowder Light | L* | a* | b* |
| Blank - No Whitener | 82.48 | −0.02 | 16.10 |
| Control - with TiO2 | 86.44 | −0.41 | 13.67 |
| Test- 2% Modified Food Starch (RS4) (Micronized) | 86.72 | 0.10 | 15.37 |

The embodiments described herein are not intended to be exhaustive or to limit the invention to the precise forms disclosed in the following detailed description. Rather, the embodiments are chosen and described so that others skilled in the art can appreciate and understand the principles and practices.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a task or adopt a configuration to. The phrase “configured” can be used interchangeably with other similar phrases such as arranged and configured, constructed and arranged, constructed, manufactured and arranged, and the like.

1. A processed food product comprising:
a modified food starch (RS4) comprising at least 70 wt. % fiber and particle size of dv 98% less than 25 μm, wherein the brightness (L*) value of the processed food product is greater than 70.

2. The processed food product of claim 1, containing a moisture content of at least about 50 wt. %.

3. The processed food product of claim 1, comprising the modified food starch (RS4) in an amount from 1 wt. % to 5 wt. %.

4. The processed food product of claim 1, comprising the modified food starch (RS4) in an amount from 1 wt. % to 3 wt. %.

5. The processed food product of claim 1, comprising at least one of a retorted food product, a heat-treated food product, and a shelf-stable food product.

6. The processed food product of claim 1, selected from the group consisting of reduced-fat/low-fat refrigerated soups, reduced fat/low fat shelf-stable soups, shelf-stable cheese dips, shelf-stable white sauces, salad dressings, bakery products, and baked snacks.

7. The processed food product of claim 1, wherein the processed food product is titanium-dioxide free.

8. The processed food product of claim 1, wherein the processed food product has a titanium-dioxide content of less than 0.1 wt. %.

9. An opacifying composition comprising:
a modified food starch (RS4) comprising at least 70 wt. % fiber and particle size of dv 98% less than 25 μm, wherein the brightness (L*) value of the composition is greater than 80 at a concentration of 1 wt. % in an aqueous solution.

10. The opacifying composition of claim 9, the modified food starch (RS4) is derived from one or more of botanical sources wheat, corn, potato, rice, and tapioca starches.

11. The opacifying composition of claim 9, the modified food starch is a cross-linked resistant starch (RS4) with at least 70% dietary fiber.

12. The opacifying composition of claim 9, the modified food starch (RS4) having at least 50% particles less than 7 μm and 100% less than 25 μm.

13. The opacifying composition of claim 9, the modified food starch (RS4) having at least 85% of particles less than 10 μm and 99% of particles less than 25 μm.

14. The opacifying composition of claim 9, the modified food starch (RS4) having 99% of particles less than 25 μm.

15. A method of making a processed food product comprising:
adding an opacifying composition to a formulation, the opacifying composition comprising:
a modified food starch (RS4) with at least 70 wt. % dietary fiber and particle size of dv 98% less than 25 μm;
forming an emulsion with the formulation and the opacifying composition;
blending the emulsion with other components to form a mixture; and
processing the mixture to form a finished product.

16. The method of claim 15, wherein processing comprises heat treating the mixture.

17. The method of claim 15, wherein the Hunter Colorimeter brightness (L*) value of the composition decreases by less than about 15 as a result of heat treating the mixture.

18. The method of claim 15, wherein the processed food product contains less than 5 grams of fat per serving.

19. The method of claim 15, where in the processed food product contain less than 1 gram of fat per serving.

20. The method of claim 15, wherein the processed food product contains less than 100 calories per serving.
